(19) United States
(12) Patent Application Publication
(10) Pub. No.: US 2025/0057124 A1
(43) Pub. Date: Feb. 20, 2025

(54) ANIMAL TOY SUPPORT

(71) Applicant: PetPals Group, Inc., Ontario, CA (US)

(72) Inventor: Yong Sun, Ontario, CA (US)

(21) Appl. No.: 18/807,894

(22) Filed: Aug. 16, 2024

Related U.S. Application Data
(60) Provisional application No. 63/532,912, filed on Aug. 16, 2023.

(51) Int. Cl. A01K 15/02

(52) U.S. Cl. CPC A01K 15/025

(57) ABSTRACT

An animal toy support is provided. The animal toy includes a substantially planar body; a first opening, having a first opening diameter, formed within the planar body, the first opening configured to receive a first attachment member; a second opening, having a second opening diameter, formed within the planar body, the second opening configured to receive a second attachment member; and a third opening, having a third opening diameter, formed within the planar body, the third opening configured to receive a third attachment member.

### CLAIM OF PRIORITY UNDER 35 U.S.C. § 119

The present application for patent claims priority to U.S. Provisional Application No. 63/532,912 entitled “ANIMAL TOY”, filed Aug. 16, 2023, and is hereby expressly incorporated by reference herein.

### FIELD

The present disclosure relates to animal toy supports and more particularly to a support member for a cat teaser.

### BACKGROUND

The cat teaser market is large and growing as the cat wand has proved to be one of the best ways to stimulate cats to play and exercise as well as create critical fun times between the pet owner and cat.

Cat teaser toys, also known as interactive cat toys, are designed to engage a cat's natural hunting instincts, providing physical exercise and mental stimulation. These toys typically consist of a long stick or wand, with a string or other material attached, which dangles a small object, feather, or other enticing element at the end. The person handling the toy can manipulate it to mimic the movements of prey, encouraging the cat to chase, pounce, and engage in playful activities.

The concept of cat teaser toys has been around for decades, evolving from simple homemade contraptions to more sophisticated designs. Traditionally, these toys were basic, consisting of a piece of string or ribbon attached to a stick. However, as understanding of feline behavior and needs has advanced, so too have the designs and materials used in these toys. Modem cat teaser toys often incorporate elements that enhance their durability, safety, and appeal to cats, such as non-toxic materials, varying textures, and sound elements like bells or crinkling paper.

The need for cat teaser toys arises from the domesticated cat's inherent need for stimulation and exercise. In the wild, cats spend a significant portion of their day hunting, which provides both physical activity and mental engagement. Indoor cats, however, do not have the same opportunities to exercise these instincts, leading to potential issues such as obesity, boredom, and behavioral problems. Cat teaser toys help fill this gap by providing a safe and enjoyable way for cats to express their natural behaviors, maintain a healthy weight, and strengthen the bond between the pet and its owner.

Despite the availability of various cat teaser toys on the market, there is always room for innovation. Many existing designs can become quickly damaged due to vigorous play, or they may fail to sustain a cat's interest over time. Additionally, safety concerns have arisen with some toys, as small or loose parts can pose choking hazards, and certain materials may not be durable enough to withstand a cat's sharp claws and teeth.

While there are many cat teaser toys on the market, pom-pom toys fastened on a cat tree and cat wands, once a cat bites the toy off cat tree or the wand, each toy and/or wand becomes useless and ends up in the trash can which is harmful to the environment. Once a toy is bitten off, it is very difficult to add another toy onto the cat tree or the wand.

### BRIEF SUMMARY

The following presents a simplified summary of one or more aspects of the present disclosure to provide a basic understanding of such aspects. This summary is not an extensive overview of all contemplated features of the disclosure. It is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description presented below.

In one example, an animal toy support is provided. The animal toy includes a substantially planar body; a first opening, having a first opening diameter, formed within the planar body, the first opening configured to receive a first attachment member; a second opening, having a second opening diameter, formed within the planar body, the second opening configured to receive a second attachment member; and a third opening, having a third opening diameter, formed within the planar body, the third opening configured to receive a third attachment member.

According to one aspect, the substantially planar body is made from a material composed of Polypropylene Plastic and Thermoplastic Rubber.

According to another aspect, the first, second and third openings have a circular configuration.

According to yet another aspect, the first opening diameter is the same as the second opening diameter.

According to yet another aspect, the third opening diameter is the same as the first and second opening diameters.

According to yet another aspect, the first opening diameter is different than the second opening diameter.

According to yet another aspect, the third opening diameter is different than the second and third opening diameters.

According to yet another aspect, the first opening diameter is 4 mm, the second opening diameter is 11 mm, and the third opening diameter is 30 mm.

According to yet another aspect, a distance between a center of the second opening and a center of the third opening is 30 mm.

According to yet another aspect, the substantially planar body is flexible.

According to yet another aspect, the animal toy support is a tear drop shape.

According to yet another aspect, a widest portion the tear drop shape is 38 mm.

According to yet another aspect, the substantially planar body has a uniform thickness.

According to yet another aspect, the uniform thickness is 3 mm.

According to yet another aspect, the animal toy support further includes an attachment member having a first end an and opposing second end, wherein the first end of the attachment member is detachably secured to the first, second, or third openings.

According to yet another aspect, the second end of the attachment member is detachably secured to an object.

According to yet another aspect, the object is a ball.

According to yet another aspect, the attachment member is a string.

According to another example, an animal toy support is provided. The animal toy support consists of a substantially planar body; a first opening, having a first opening diameter, formed within the planar body, the first opening configured to receive a first attachment member; a second opening, having a second opening diameter, formed within the planar body, the second opening configured to receive a second attachment member; and a third opening, having a third opening diameter, formed within the planar body, the third opening configured to receive a third attachment member; wherein the first, second and third openings have a circular configuration; wherein the first opening diameter is different than the second opening diameter; wherein the third opening diameter is different than the second and third opening diameters; and wherein the animal toy support is a tear drop shape.

### BRIEF DESCRIPTION OF THE DRAWINGS

The features, nature, and advantages of the present aspects may become more apparent from the detailed description set forth below when taken in conjunction with the drawings in which like reference characters identify correspondingly throughout.

FIG. 1 illustrates a top rear perspective view of an animal toy support according to one aspect of the present disclosure.

FIG. 2 illustrates a top plan view of the animal toy support of FIG. 1.

FIG. 3 illustrates a ball secured to the animal toy support of FIG. 1.

FIG. 4 illustrates a cat wand secured to the animal toy support of FIG. 1.

FIG. 5 illustrates the animal toy support of FIG. 1 having an attachment member secured to each opening.

FIG. 6 illustrates the animal toy support of FIG. 1 secured to an upper surface of a platform.

FIG. 7 illustrates the animal toy support of FIG. 1 secured to a lower surface of a platform.

### DETAILED DESCRIPTION

In the following description, specific details are given to provide a thorough understanding of the embodiments. However, it will be understood by one of ordinary skill in the art that the embodiments may be practiced without these specific details.

The term “comprise” and variations of the term, such as “comprising” and “comprises,” are not intended to exclude other additives, components, integers or steps. The terms “a,” “an,” and “the” and similar referents used herein are to be construed to cover both the singular and the plural unless their usage in context indicates otherwise. The word “exemplary” is used herein to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation.

The term “attachment member” may refer to any type of flexible or non-flexible connecting element used to secure or link different components of a device or structure, such as a string, cord, tether, rope, chains, rigid bars, elastic band, strap, wire, rod, or similar connector. This member can be designed to allow for movement, adjustability, or stability, depending on the intended function of the connected elements.

An animal toy may refer to a cat teaser, ball, bell, crinkling material, feather, or other object designed to engage a pet's natural instincts, such as chasing, pouncing, or chewing, providing both entertainment and physical exercise. This can encompass a wide range of toys, including those that cater to different behaviors and preferences of pets.

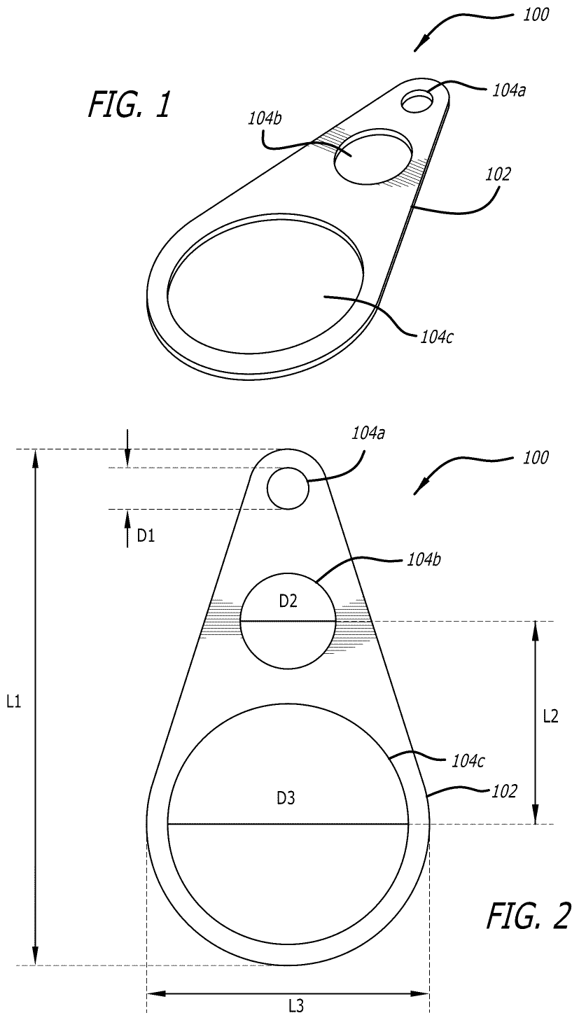

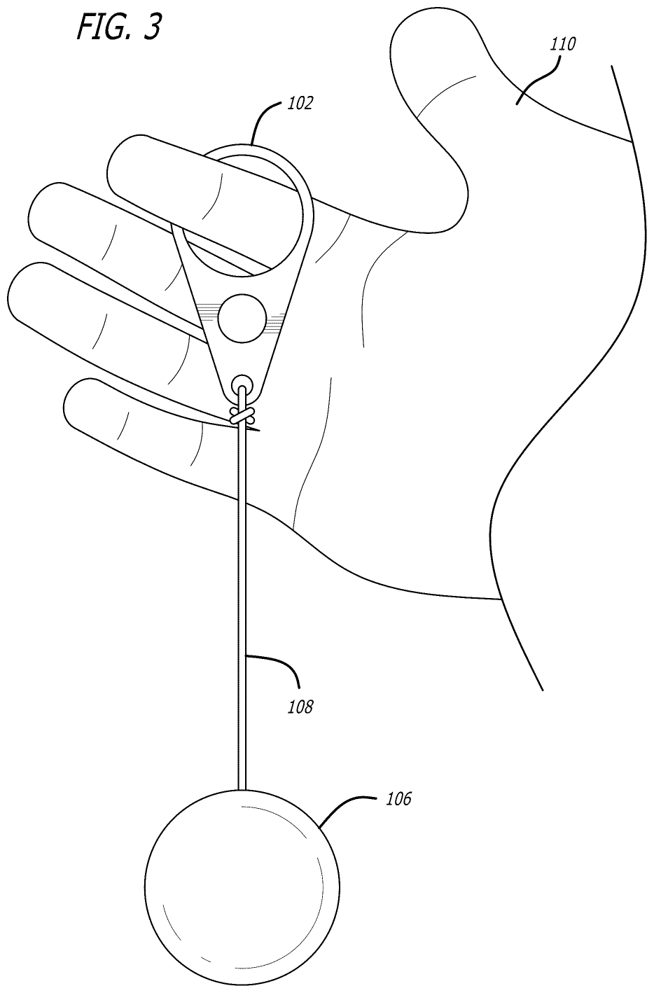

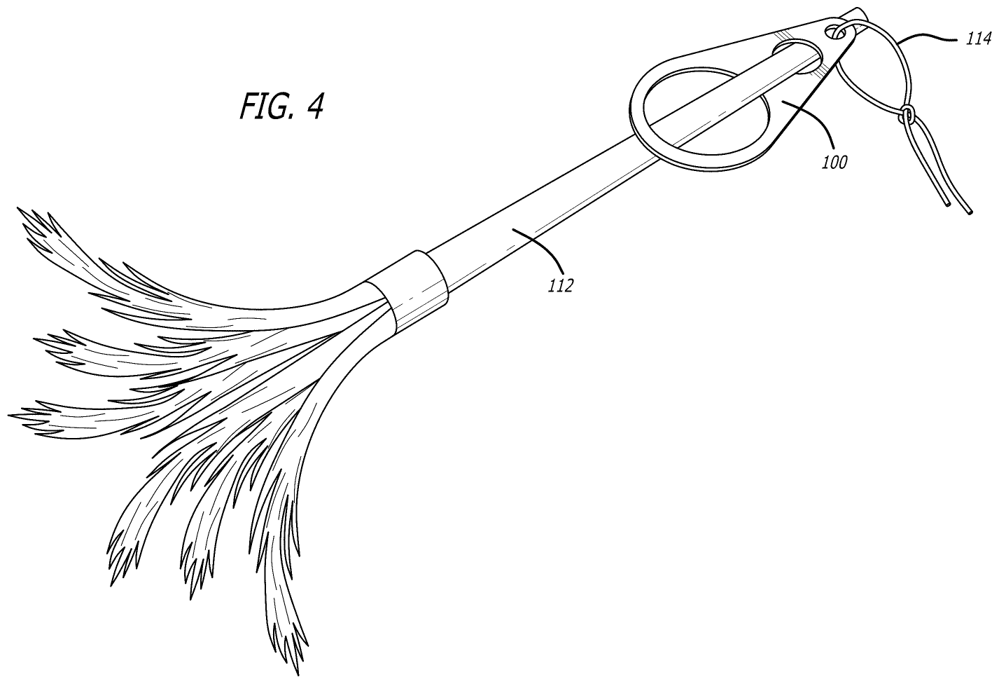

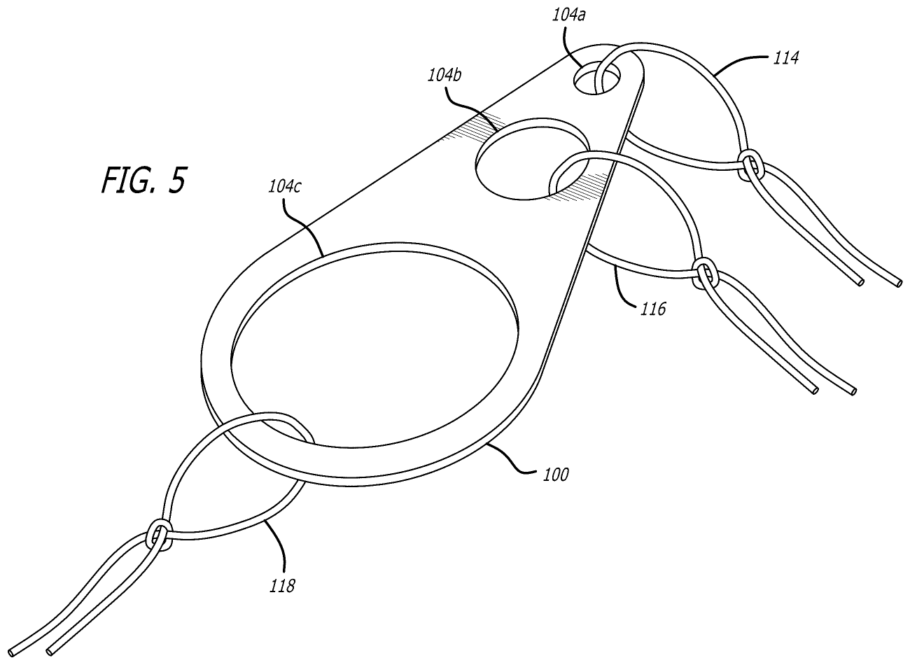

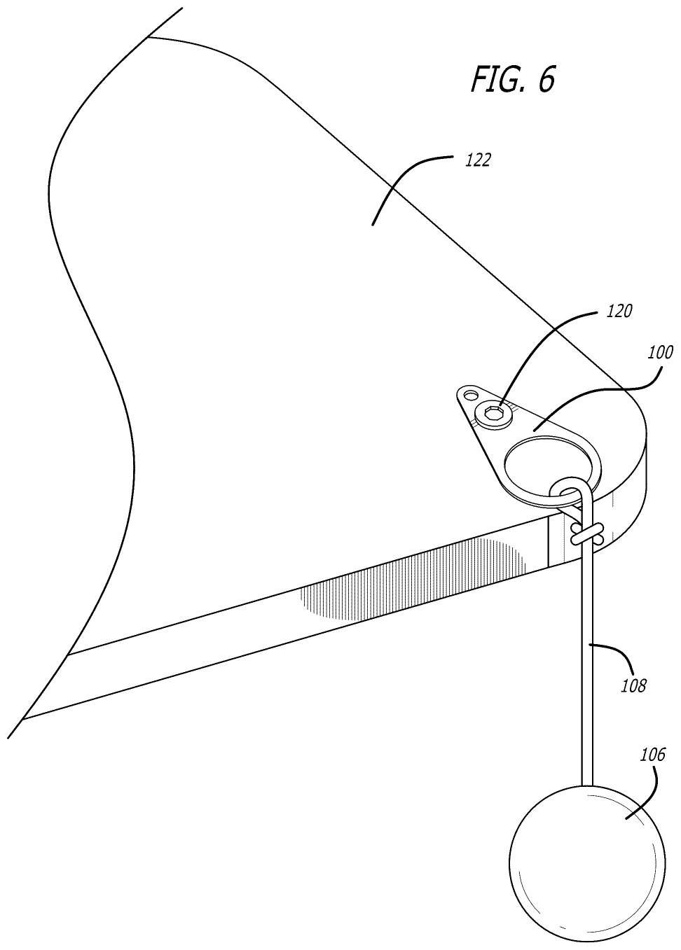

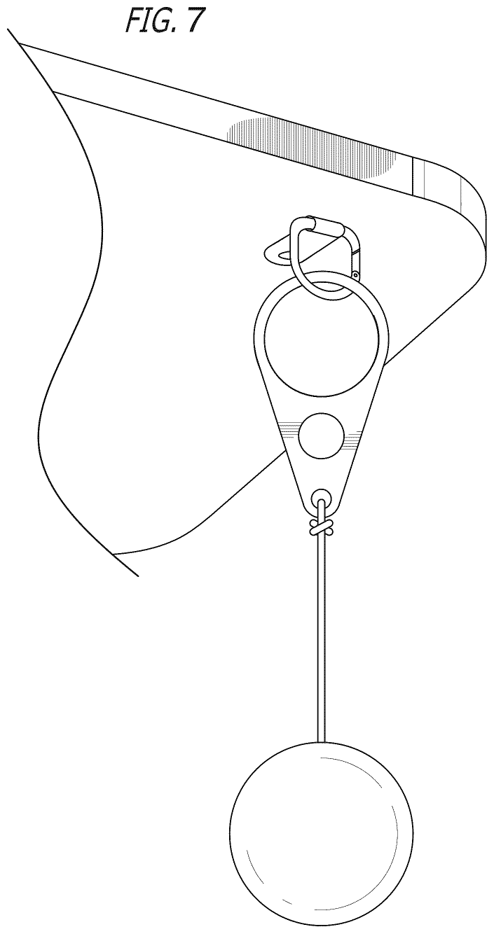

FIG. 1 illustrates a top rear perspective view of an animal toy support according to one aspect of the present disclosure. FIG. 2 illustrates a top plan view of the animal toy support of FIG. 1. FIG. 3 illustrates a ball secured to the animal toy support of FIG. 1. FIG. 4 illustrates a cat wand secured to the animal toy support of FIG. 1. FIG. 5 illustrates the animal toy support of FIG. 1 having an attachment member secured to each opening. FIG. 6 illustrates the animal toy support of FIG. 1 secured to an upper surface of a platform. FIG. 7 illustrates the animal toy support of FIG. 1 secured to a lower surface of a platform. The following discussion refers interchangeably to FIGS. 1-7.

As shown, the animal toy support 100 may be comprised of a flexible or non-flexible substantially planar body 102 having one or more openings 104a-104c. The flexible planar body 102 may be made from any material known in the art, such as a material that composed of Polypropylene Plastic and Thermoplastic Rubber. According to one example, the material may be composed of 98% Polypropylene Plastic and 2% Thermoplastic Rubber. In one aspect, the planar body may have uniform thickness.

According to one example, the flexible planar body 102 has three (3) openings, however this is by way of example only and the flexible planar body 102 may have more than (3) openings or less than three (3) openings. The openings may be circular, square, rectangular, oval, triangular, pentagons, or any other polygonal shape. In one aspect, the diameters of each of the openings may be different. Alternatively, all the openings may be of the same size, or two openings may be of the same size and the third opening a different size.

FIG. 2 illustrates an example of the animal toy support having three (3) different sized openings, a first opening 104a, a second opening 104b, and a third opening 104c. The first opening has a first opening diameter D1, the second opening has a second opening diameter D2, and the third opening has a third opening diameter D3. By way of example only, the first opening diameter D1 is 4 mm, the second opening diameter D2 is 11 mm, and the third opening diameter D3 is 30 mm.

In other aspects, the first opening diameter D1 may be less than or greater than 4 mm, the second opening diameter D2 may be less than or greater than 11 mm, and the third opening diameter D3 may be less than or greater than 30 mm. For example, the first opening diameter D1 may be between 1 mm and 10 mm, the second opening diameter D2 may be between 5 mm and 29 mm, and the third opening diameter D3 may be between 11 mm and 40 mm. Alternatively, the first opening diameter D1 may be between 2 mm and 8 mm, the second opening diameter D2 may be between 7 mm and 25 mm, and the third opening diameter D3 may be between 20 mm and 40 mm. These dimensions are by way of example only, and the dimensions may be any dimension capable of fitting on the substantially planar body.

According to one example, the length L1 of the animal toy support 100 is 66.74 mm and the length L2 between the center of the second opening 104b and the center of the third opening 104c is 30 mm. These dimensions are by way of example only and the length L1 may be less than or greater than 66.74 mm and the length L2 may be less than or greater than 30 mm.

As shown, the animal toy support 100 may have a tear drop shape, however other polygonal shapes may be utilized including, but not limited to, square, rectangular, circular, and oval. When in a tear drop shape as shown in FIG. 2, the widest portion L3 of the tear drop shape may be 38 mm. In one aspect, the thickness of the flexible planar body 102 may be 3 mm. These dimensions are by way of example only and other dimensions may be utilized.

FIG. 3 illustrates a ball 106 secured to the animal toy support 100 of FIG. 1. As shown, an attachment member 108 is used to detachably secure the ball 106 to the animal toy support. The attachment member may be a string, yarn, rope, chain, or any other type of flexible or non-flexible connecting element 108 used to secure or link different components together.

The attachment member has a first end and a second opposing end. The first end of the attachment member 108 may be secured to an animal toy 106, such as a ball, while the second end of the attachment member 108 is secured to one of the openings, for example the first opening 104a, on the animal toy support 100. As illustrated in FIG. 3, a user may hold on to the animal toy support 100 to play with an animal, such as a cat. For example, the user 110 may insert a finger into one of the openings, such as the third opening 104c. By waving or flicking the animal toy support, the user 110 can make the attached object move in a way that mimics the behavior of small animals like birds, insects, or rodents. This encourages the cat to chase, pounce, and play, providing both physical exercise and mental stimulation.

Turning to FIG. 4, a cat teaser or wand 112 secured to the animal toy support 100 is illustrated. The cat teaser or wand 112 may include an elongated rod having a first end and an opposing second end. The first end of the elongated rod may have feathers or other objects secured thereon. The elongated rod may be made of wood, plastic, or any other material known in the art and may be flexible or non-flexible (i.e. rigid). To secure the elongated rod to the animal toy support 100, the user may insert the second end of the elongated rod through one side of an opening in the animal toy support and then through a different opening in the animal toy support. As shown in FIG. 4, the third opening 104c and the second opening 104b may be utilized. Furthermore, the elongated rod may be straight or have a swirl or curved style. The animal toy support 100 may further include an attachment member 114, such as a string, detachably secured to the first opening 104a.

FIG. 5 illustrates the animal toy support of FIG. 1 having an attachment member 114, 116, 118 secured to each opening in the animal toy support 104a-104c.

Turning to FIG. 6, the animal toy support of FIG. 1 is illustrated secured to a platform 122. The platform 122 has an upper surface and an opposing lower surface and the animal toy support may be detachably secured to the upper surface of the platform 122. The platform 122 may be any planar or non-planar surface for which the animal toy support 100 may be secured. The platform 122 may be a counter, table, or other surface capable of supporting an animal toy, secured by the animal toy support 100, while allowing for ease of use and accessibility during play sessions. Alternatively, the animal toy support 100 may be detachably secured to a cat tree. The animal toy support 100 may be detachably or fixedly secured to the platform 122 by a fastener 120. The fastener 120 may include a screw, bolt, nail, rivet, adhesive, or any other suitable component known in the art. The fastener 120 provides for easy securing and removal from the platform 122 for maintenance or replacement.

As shown in FIG. 6, the first end of the attachment member 108 is detachably secured to the third opening 104c of the animal toy support 100 while the second end of the attachment member 108 is detachably secured to an object 106, such as a ball, for an animal to play with.

Alternatively, the animal toy support 100 may be secured to the lower surface of the platform, as shown in FIG. 7. The animal toy support 100 may be detachably secured to the platform 122 using an open eye bolt, closed eye screw, loop fastener, bolt snap, lobster clasp, or any other fastener known in the art. As shown, one of the openings may be detachably secured to the fastener by a hook or other means.

Alternatively, the animal toy support 100 may be secured to a cat tree. Most cat trees have screws that are used to attach objects such as posts and perches. As shown, the second opening is configured to receive most of the screw sizes used in cat trees allowing consumers to easily attach the substantially planar body to the cat tree.

“Aspects” do not require that all aspects of the disclosure include the discussed features, advantages, or modes of operation. “Coupled” is used herein to means the direct or indirect coupling between two objects. For example, if object A physically touches or couples to object B, and object B touches or couples to object C, then objects A and C may still be considered coupled to one another, even if they do not directly physically touch each other.

One or more of the components and functions illustrated in the FIGS. may be rearranged and/or combined into a single component or embodied in several components without departing from the invention. Additional elements or components may also be added without departing from the invention. Additionally, the features described herein may be implemented in software, hardware, as a business method, and/or combination thereof.

While certain exemplary embodiments have been described and shown in the accompanying drawings, it is to be understood that such embodiments are merely illustrative of and not restrictive on the broad invention, and that this invention is not be limited to the specific constructions and arrangements shown and described, since various other modifications may occur to those ordinarily skilled in the art.

1. An animal toy support, comprising:
a substantially planar body;
a first opening, having a first opening diameter, formed within the planar body, the first opening configured to receive a first attachment member;
a second opening, having a second opening diameter, formed within the planar body, the second opening configured to receive a second attachment member; and
a third opening, having a third opening diameter, formed within the planar body, the third opening configured to receive a third attachment member.

2. The animal toy support of claim 1, wherein the substantially planar body is made from a material composed of Polypropylene Plastic and Thermoplastic Rubber.

3. The animal toy support of claim 1, wherein the first, second and third openings have a circular configuration.

4. The animal toy support of claim 3, wherein the first opening diameter is the same as the second opening diameter.

5. The animal toy support of claim 4, wherein the third opening diameter is the same as the first and second opening diameters.

6. The animal toy support of claim 3, wherein the first opening diameter is different than the second opening diameter.

7. The animal toy support of claim 6, wherein the third opening diameter is different than the second and third opening diameters.

8. The animal toy support of claim 3, wherein the first opening diameter is 4 mm, the second opening diameter is 11 mm, and the third opening diameter is 30 mm.

9. The animal toy support of claim 3, wherein a distance between a center of the second opening and a center of the third opening is 30 mm.

10. The animal toy support of claim 3, wherein the substantially planar body is flexible.

11. The animal toy support of claim 1, wherein the animal toy support is a tear drop shape.

12. The animal toy support of claim 11, wherein a widest portion the tear drop shape is 38 mm.

13. The animal toy support of claim 1, wherein the substantially planar body has a uniform thickness.

14. The animal toy support of claim 13, the uniform thickness is 3 mm.

15. The animal toy support of claim 1, further comprising an attachment member having a first end an and opposing second end, wherein the first end of the attachment member is detachably secured to the first, second, or third openings.

16. The animal toy support of claim 15, wherein the second end of the attachment member is detachably secured to an object.

17. The animal toy support of claim 16, wherein the object is a ball.

18. The animal toy support of claim 15, wherein the attachment member is a string.

19. An animal toy support, consisting of:
a substantially planar body;
a first opening, having a first opening diameter, formed within the planar body, the first opening configured to receive a first attachment member;
a second opening, having a second opening diameter, formed within the planar body, the second opening configured to receive a second attachment member; and
a third opening, having a third opening diameter, formed within the planar body, the third opening configured to receive a third attachment member;
wherein the first, second and third openings have a circular configuration;
wherein the first opening diameter is different than the second opening diameter;
wherein the third opening diameter is different than the second and third opening diameters; and
wherein the animal toy support is a tear drop shape.
